(19) United States
(12) Patent Application Publication
(10) Pub. No.: US 2025/0115226 A1
(43) Pub. Date: Apr. 10, 2025

(54) BRAKE ACTUATING DEVICE FOR A MOTOR VEHICLE BRAKE SYSTEM, HAVING AN ADAPTER UNIT

(71) Applicant: Continental Automotive Technologies GmbH, Hannover (DE)

(72) Inventors: Paul-Razvan Dumitrascu, Iasi (RO); Alex-Cristian Dumitru, Lunca Cetatuii (RO); Marco Müller, Lahnau (DE); Johannes Singer, Kassel (DE); Mihai Baciu, Golesti (RO)

(73) Assignee: Continental Automotive Technologies GmbH, Hannover (DE)

(21) Appl. No.: 18/911,294

(22) Filed: Oct. 10, 2024

(30) Foreign Application Priority Data
Oct. 10, 2023 (EP) 23465551.2
Oct. 11, 2023 (DE) 10 2023 209 924.1

(51) Int. Cl. B60T 13/74; B60T 8/36

(52) U.S. Cl. CPC B60T 13/745; B60T 8/3685

(57) ABSTRACT

A brake actuating device for a motor vehicle brake system comprising a hydraulic unit having a side face, on which an electric motor is arranged, wherein the electric motor drives a pressure generator, located in the hydraulic unit, for conveying a hydraulic fluid, wherein the hydraulic unit comprises a number of outlet openings in the side face, wherein an adapter unit which comprises a number of inlet openings is arranged on the side face, wherein the outlet openings of the hydraulic unit are connected in fluid communication via a respective connecting tube with the corresponding inlet openings of the adapter unit.

### TECHNICAL FIELD

The embodiments relate to a brake actuating device for a motor vehicle brake system.

### BACKGROUND

DE 10 2018 214 565 A1 discloses a brake actuating device of a motor vehicle brake system, which comprises a block-type hydraulic unit, on which an electric motor and an electronic unit are arranged. The electric motor drives a pressure generator, located in the hydraulic unit, in order to convey a hydraulic fluid under pressure in the direction of the wheel brakes of the motor vehicle brake system. To store the hydraulic fluid, a pressure medium reservoir is arranged directly on the hydraulic unit. The hydraulic unit contains electromagnetic switching valves, which are switched by means of corresponding solenoids in the electronic unit. The electronic unit serves to exercise open-loop and closed-loop control over the brake actuating device. A multiplicity of channels is drilled into the hydraulic unit, connecting the individual components of the motor vehicle brake system to one another and being connected to or disconnected from one another by means of the switching valves. Four such channels open on an outer side of the hydraulic unit into connection openings, which are provided for the connection of brake lines to the wheel brakes of the motor vehicle brake system. Commonly, these connections are arranged above the electric motor. When this brake actuating device is fastened on the left-hand side to the vehicle bulkhead, the connections point to the right into the engine compartment. Under certain installation conditions, these connections can be difficult to access to connect the wheel brake lines.

### SUMMARY

It is the object to provide a brake actuating device for a motor vehicle brake system in which the connection of brake lines is simplified.

The modular electrohydraulic brake actuating device is used in a slip-controlled motor vehicle brake system.

### BRIEF DESCRIPTION OF THE DRAWINGS

Embodiments will be found in the claims and the following description of an exemplary embodiment with reference to the figures. In the drawings:

FIG. 1 shows an exemplary brake actuating device having an adapter unit, and

FIG. 2 shows the adapter unit in a first perspective view.

### DETAILED DESCRIPTION

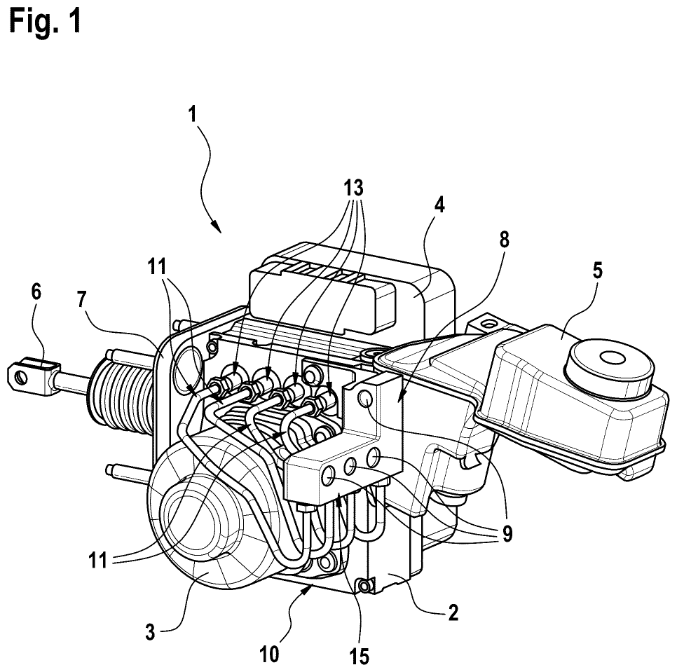

FIG. 1 shows an electrohydraulic brake actuating device 1 for a motor vehicle brake system having a central hydraulic unit 2. An electric motor 3 is attached to a side face 10 of hydraulic unit 2. Electric motor 3 drives a pressure generator arranged in hydraulic unit 2, which pressure generator conveys a hydraulic fluid in the direction of wheel brakes of the motor vehicle brake system. The pressure generator can be designed as a double-stage piston pump or as a linear actuator. To supply the hydraulic fluid, a pressure medium reservoir 5 is attached to hydraulic unit 2.

An electronic unit 4 is arranged on hydraulic unit 2 on the side opposite the electric motor 3. Electronic unit 4 serves to exercise open-loop and closed-loop control over brake actuating device 1. Within hydraulic unit 2 there are electromagnetically actuable switching valves, which are driven by solenoids of the electronic unit 4. The switching valves are used to control the flow of fluid between the individual components of the motor vehicle brake system. Thus, a multiplicity of channels is drilled within hydraulic unit 2, connecting the individual components of the motor vehicle brake system to one another. Four of these channels open into respective outlet openings 13 on side face 10 of hydraulic unit 2.

According to the example, an adapter unit 8 is attached to side face 10 of hydraulic unit 2. According to the example, adapter unit 8 comprises four connection openings 9 for brake lines, which lead to the wheel brakes of the motor vehicle brake system. To connect these connection openings 9 to hydraulic unit 2, adapter unit 8 comprises inlet openings which are not visible in FIG. 1. The inlet openings of adapter unit 8 are fluidically connected via connecting tubes 11 to the outlet openings 13 of the hydraulic unit 2. Each one of the outlet openings 13 is thus connected to a corresponding inlet opening of the adapter unit 8. Connecting tubes 11 are connected to the respective outlet openings 13 and inlet openings on both sides by means of union nuts. Connecting tubes 11 may be made from copper or a copper alloy and preferably coated with an aluminum-polyamide coating. Connecting tubes 11 are of rigid and curved design. In this case, connecting tubes 11 are guided around the electric motor 3.

By means of adapter unit 8 according to the example, connection openings 9 for the wheel brake lines are relocated to a more accessible position in the engine compartment. This makes it easier to connect the brake lines to brake actuating device 1. Adapter unit 8 creates the possibility of the modular principle, and it is therefore possible to use a conventional hydraulic unit 2 for brake actuating device 1 and no special design is required. In the applications in which access to the connection openings for the wheel brake lines is made more difficult, additionally attached adapter unit 8 is used. This increases flexibility in the installation of brake actuating device 1 in a motor vehicle.

Also provided on hydraulic unit 2 is a flange 7, by means of which brake actuating device 1 is attached to a fastening point in the motor vehicle, wherein a piston rod 6 projecting from flange 7 leads into the vehicle interior for actuation by a pedal.

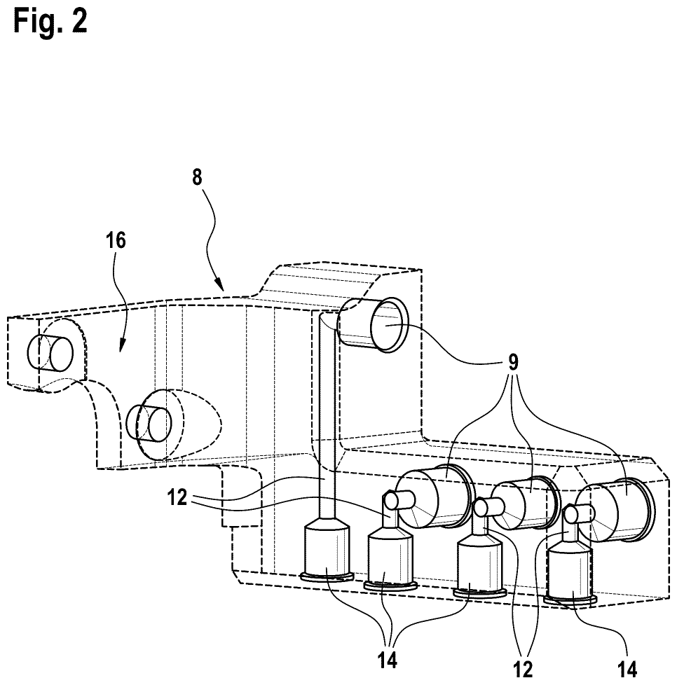

FIG. 2 shows adapter unit 8 in a phantom view. It shows the underside inlet openings 14 to which the connecting tubes are screwed. Inlet openings 14 merge into channels 12 which in turn open into the connection openings 9 for the wheel brakes. Channels 12 are drilled into the adapter unit 8 which may be aluminum and closed with a plug if necessary. In this way, a fluidic connection is created from the respective inlet openings 14 to the corresponding connection openings 9. Three of the connection openings 9 are arranged on one connection surface 15 which is also oriented at a right angle to the side face of the hydraulic unit. A fourth connection opening 9 is arranged on another connection surface of the adapter unit 8 which is oriented parallel to the side face of the hydraulic unit. Furthermore, adapter unit 8 comprises a connecting flange 16 with two openings by means of which said flange is screwed to the hydraulic unit.

1. A brake actuating device for a motor vehicle brake system comprising:
a hydraulic unit for conveying a hydraulic fluid, wherein the hydraulic unit comprises a number of outlet openings in a side face thereof;
an electric motor arranged on the side face, wherein the electric motor drives a pressure generator, located in the hydraulic unit; and
an adapter unit which comprises a number of inlet openings is arranged on the side face, wherein the outlet openings of the hydraulic unit are connected in fluid communication via a respective connecting tube with the corresponding inlet openings of the adapter unit.

2. The brake actuating device as claimed in claim 1, wherein the adapter unit comprises a connection surface having a number of connection openings for fluidly connecting wheel brakes of the motor vehicle brake system.

3. The brake actuating device as claimed in claim 2, wherein the connection surface of the adapter unit is oriented at an angle to the side face of the hydraulic unit.

4. The brake actuating device as claimed in claim 1, wherein in each case one of the inlet openings is connected to in each case one of the connection openings via a channel made in the adapter unit.

5. The brake actuating device as claimed in claim 4, wherein the channels are drilled into the adapter unit.

6. The brake actuating device as claimed in claim 1, wherein the connecting tubes are at least made from copper.

7. The brake actuating device as claimed in claim 1, wherein the connecting tubes are of rigid and curved design.

8. The brake actuating device as claimed in claim 1, wherein the connecting tubes are guided at least partly around a housing of the electric motor.

9. The brake actuating device as claimed in claim 1, wherein the adapter unit is arranged above the electric motor on the hydraulic unit in an installed position of the brake actuating device.

10. The brake actuating device as claimed in claim 1, wherein the adapter unit is connected to the hydraulic unit with a screwed connection.
